(19) United States
(12) Patent Application Publication
(10) Pub. No.: US 2008/0268714 A1
(43) Pub. Date: Oct. 30, 2008

(54) Jack and method for fixation of jack to panel

(76) Inventor: Joel G. Bump, Prescott, AZ (US)

Correspondence Address: Elliott N. Kramsky, Esq., Suite 400, 5850 Canoga Avenue, Woodland Hills, CA, 91367, US

(21) Appl. No.: 11/903,457

(22) Filed: Sep. 24, 2007

Related U.S. Application Data
(60) Provisional application No. 60/926,844, filed on Apr. 30, 2007.

(51) Int. Cl. H01R 31/00; B21D 39/00; B23P 11/00

(52) U.S. Cl. 439/650; 29/505; 72/412

(57) ABSTRACT

A method for fixation of a jack to a panel or bracket of an electronics module. A jack having an encircling flange is machined to include a barrel having at least one longitudinal knurl and an inwardly-tapered interior section. A swaging tool includes a body having a lower surface with an open circular channel arranged to circumscribe the circular open end of the barrel of the jack. The jack is fixed to a circular port within the panel by inserting the jack into the port so that the flange contacts a surface of the panel and then applying a downward-acting force onto the swaging tool aligned with open end of the barrel to compressively fix the jack to the panel.

### REFERENCE TO RELATED APPLICATION

The present application claims priority from Provisional Patent Application Ser. No. 60/926,844 of inventor Joel G. Bump covering “Jack and Method For Fixation of Jack to Panel” filed in the United States Patent and Trademark Office on Apr. 30, 2007.

### BACKGROUND

1. Field of the Invention

The present invention relates to jacks and methods of fixation of jacks to the panels of electronics chassis. More particularly, this invention pertains to a jack suitable and to the method of swaging the jack to the panel.

2. Description of the Prior Art

Phono jacks are commonly used in consumer audio, video and digital devices for both the input and output of signals to a modular array of electronic elements. Such an array of elements is commonly contained within a frame comprising a number of boundary panels.

The jacks are installed directly to the metal front or rear panels of finished products or to internal metal brackets, panels or circuit boards that permit the jack to protrude through the (metal or plastic) outer shell or panel of the finished product. The jack is routinely fixed by swaging it to the panel or bracket.

Prior art swaging operations roll the barrel of the jack over until it contacts the backside of the panel or bracket. As a result, pressure applied by the rolled edge and by slight expansion of the smooth metal barrel of the jack provide the only forces to keep the jack secured to the panel. The smoothness of the wall of the barrel of the jack, contacting the smooth inner diameter of the port that has been drilled or punched in the panel, leave the jack subject to possible eventual rotation with respect to the panel.

During normal use, a male connector is pushed into the jack and seated therein with rotating action. As the outer shell of the connector applies pressure to the perimeter of the panel-mounted jack body, such rotational action may compromise the holding integrity of the jack. Users often additionally apply angular force to the connector to help insert or easily remove it. This places additional mechanical stress on swage integrity.

The rolling swage fixation process requires that a very thin gauge metal be employed for the barrel of the jack. Such thin gauge metal acts to weaken the jack in the face of the pressures applied to it by connector insertion and removal. Repetitive use often results in rotation of the jack with respect to the port in the panel. Such rotation may cause the attachment of the jack to the panel to loosen and, in some cases, fail.

Loosening of the attachment of jack to panel can degrade operation of the electronic device as the mechanical contact between jack body and panel provides the ground connection for signals. A loose connection between jack body and panel will cause the signal transmitted through the jack to become intermittent and result in electrical failure of the jack. As the jack becomes loose, the center conductor is mechanically stressed and may also fail.

Prior art jacks are also known having barrels with threaded outer walls for insertion into an interiorly-threaded port of a panel. The threaded barrel mounts through the thickness of the panel and is secured by a nut. Although generally more robust than jacks utilized in a roll swaging process, their installation is time-consuming. While threaded jacks are able to withstand damage from lateral or angular forces, they are subject to eventual loosening through repetitive use and vibration.

### SUMMARY OF THE INVENTION

The present invention addresses the preceding and other shortcomings of the prior art by providing, in a first aspect, a method for securing a jack to a panel of an electronics chassis. Such method is begun by machining a block of metal to provide a jack of the type that includes a barrel having an encircling flange, at least one longitudinal knurl and an inwardly-tapered interior section.

A swaging tool is also provided. Such tool includes a body having a lower surface. An open circular channel is formed in the lower surface. The circular channel includes a pair of spaced-apart planar walls and a planar roof. The inner wall is of lesser diameter and the outer wall is of greater diameter than the diameter of the open end of the barrel of the jack.

The jack is inserted into a circular port in the panel so that the flange contacts a surface of the panel throughout and the barrel extends beyond the opposed surface of the panel. The swaging tool is then aligned with the end of the jack so that the end of the barrel is circumscribed by the open circular channel of the swaging tool. A force is applied to the swaging tool so that the lower surface of the tool is directed to contact the open end of the jack and to exert a compressive force upon the barrel of the jack.

In a second aspect, the invention provides a jack. Such jack includes a barrel having an encircling flange, at least one longitudinal knurl and an inwardly-tapered interior section.

In a third aspect, the invention provides a swaging tool. Such tool includes a body having a lower surface. An open circular channel is formed in the lower surface. The circular channel includes a pair of spaced-apart planar walls and a planar roof.

The preceding and other features of the invention are described in a detailed description that follows. Such description is accompanied by a set of drawing figures. Numerals of the drawing figures, corresponding to those of the written description, point to the features of the invention. Like numerals refer to like features throughout both the written description and the drawings.

### BRIEF DESCRIPTION OF THE DRAWINGS

FIG. 1 is a side elevation view of a jack in accordance with an embodiment of the invention;

FIGS. 2(a) and 2(b) are a cross-sectional view of the jack taken at line 2(a)-2(a) of FIG. 1 and an enlarged detail view taken at line 2(b)-2(b) of FIG. 2(a) respectively;

FIGS. 3(a) through 3(c) are side elevation, cross-sectional (taken at line 3(b)-3(b) of FIG. 3(a)) and bottom plan views, respectively, of components of a swaging tool in accordance with an embodiment of the invention;

FIG. 4 is a side elevation view of a swaging tool with jack arranged therein for fixation to a panel of an electronic module in accordance with an embodiment of the invention; and

FIGS. 5(a) and 5(b) are a series of enlarged cross-sectional views for illustrating the swaging of a jack to a panel in accordance with an embodiment of the invention.

### DETAILED DESCRIPTION OF THE PREFERRED EMBODIMENT

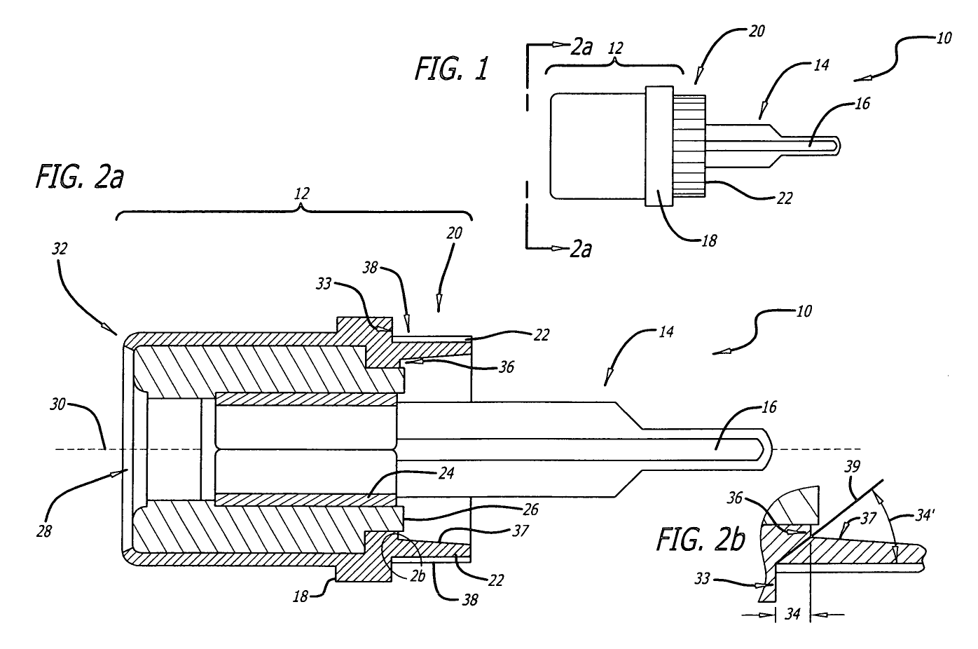

FIG. 1 is a side elevation view of a jack 10 in accordance with an embodiment of the invention. The jack 10 comprises a generally-cylindrical outer shell 12 that houses a protruding pin 14. The outer shell 12 is preferably machined from a metal rod to offer a number of significant functional features (discussed below) that cannot be achieved with a jack having a barrel formed of sheet metal.

An axial groove 16 is provided for stiffening the elongated pin 14 to resist bending upon insertion into a mating plug of an electronic component (not shown). The shell 12, which provides coaxial shielding of an electrical connection affected by means of the jack 10, includes an encircling flange 18 and a barrel 20. As can be seen, the barrel 20 comprises a plurality of longitudinal knurls 22. Such knurls 22 enhance the resistance of the jack 10, when fixed to a panel or the like, to rotational forces that would otherwise erode the grounding quality. The presence of the knurling causes the otherwise-smooth periphery of an insertion port of a panel to deform under press-fit insertion pressure, thereby acquiring a complementary texture consisting of minute alternating peaks and depressions. The knurled exterior of the barrel 20 thereafter interlocks with the above-described texture to form a bond that is highly resistant to rotational force.

Other features of the jack 10 are made apparent in FIG. 2(a), a cross-sectional view of the jack 10 taken at line 2(a)-2(a) of FIG. 1. The metallic pin 14 is formed integrally with a metallic base sheet 24 that is rolled into a tube for insertion within a generally-tubular molded interior 26, preferably comprising an electrical insulator such as NYLON®, of the jack 10. An aperture 28 at the bottom of the shell 12 is aligned with the axis of symmetry 30 of the open tubular interior 26 of the jack 10. The aperture 28 permits the jack 10 to function, when inserted into a panel of an electrical module, as a conductor of electricity between a plug end 32 and the pin 14. The plug end 32 provides the female element and the pin 14 the male element for making electrical connection through the jack 10. For example, the plug end 32 may receive a plug or pin at the terminus of a wire, as the pin 14 is received by the female element of a circuit board.

As mentioned above, the shell 12 is preferably machined from a rod of, e.g., number 360 half hard free cutting brass bar stock, permitting the shell 12, including the barrel 20, to be formed to a specific shape for enabling a swaging process that cannot be achieved by means of jacks of conventional shape and fabrication. The detailed shape of the barrel 20 will be seen to provide a design that will resist fracture during the swaging process described below. As illustrated in FIGS. 2(a) and 2(b), an edge 33 of the flange 18 is offset by an amount 34 from an annular edge 36 of the barrel 20. The offset amount 34 will be seen to provide metal that is drawn into the barrel 20 to prevent the barrel 20 from fracturing as a result of the swaging process. The inventor has found that a slight outward tapering of the inner wall 37 of the barrel 20 is required to prevent it from swelling inwardly during swaging as described below. The taper additionally permits the removal of a swaging tool, described below, from the jack 10 after swaging.

The swaging operation will be seen to cause the barrel 20 to flare outwardly. The inventor has found that the angle of flaring should be limited to approximately one half the value of an angle 34′, illustrated in FIG. 2(b), that is subtended by the outer wall 38 of the barrel 20 (which is parallel to the axis of symmetry 30 before swaging) and an imaginary line 39 adjoining the points of contact of the outer wall 38 with the edge 33 of the flange 18 and the annular edge 36 with the inner wall 37 of the barrel 20 respectively to prevent fracture of the jack 10 upon swaging to a mounting panel. The inventor has further found that the value of the offset angle 34′ is preferably approximately eighteen degrees while the outer wall 38 of the barrel 20 should flare outwardly by no greater than 5 degrees when the barrel 20 achieves first contact with a mounting port of a panel and no greater than 9.2 degrees upon completion of the swaging operation (discussed and illustrated below).

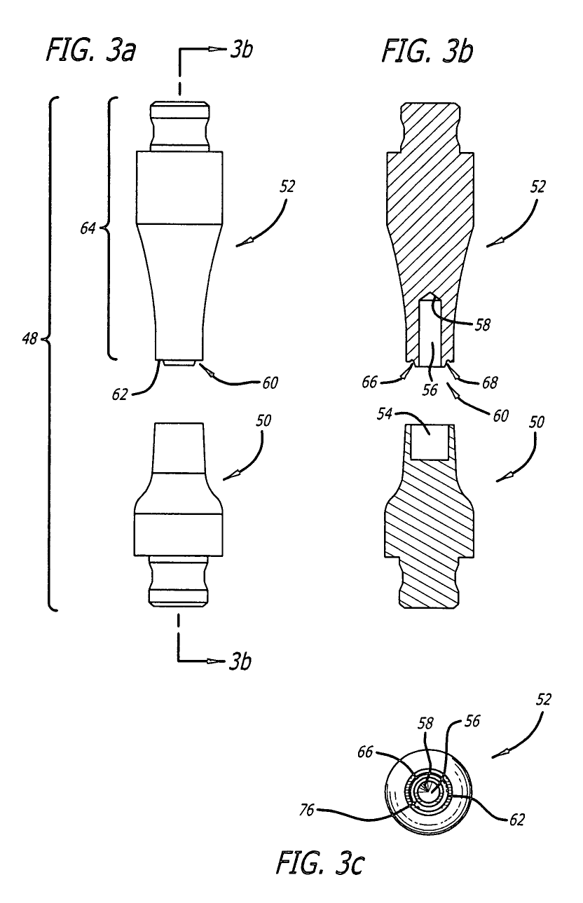

FIGS. 3(a) through 3(c) are side elevation, cross-sectional (taken at line 3(b)-3(b) of FIG. 3(a)) and bottom plan views, respectively, of components of a swaging tool 48 in accordance with an embodiment of the invention. The tool 48 is mounted when in use in an Arbor press. Arbor presses are well known in the art, employing various technologies (e.g. rack, cam, servo, hydraulic, etc.) to apply the linear force required for swaging operations. While the method of the invention is not limited to Arbor presses, a representative hydraulically-powered Arbor press for use in the invention is commercially available from Haeger, Incorporated of Oakdale, Calif. Such a press, with tool 48, permits the barrel 20 of the jack 10 to the guided in accordance with the invention at the same time that a measured amount of pressure is applied for its fixation to a panel. Such a fixation process will be described with reference to subsequent drawing figures.

Viewing FIGS. 3(a) and 3(b) in combination, it is seen that the tool 48 comprises two parts, a first swaging tool member or base 50 for receiving the plug end of the jack 10 and a second swaging tool member or hammer 52 for receiving the pin end of the jack 10. In use, the hammer 52 is actuated by the Arbor Press to apply downward pressure controllably to fix the jack 10 to a panel.

The base 50 of the tool 48 includes a hollowed upper end defining a cup-like cavity 54 for receiving and positioning the plug end of the jack 10. Such cavity 54 is aligned with an elongated cavity 56 formed in the bottom of the hammer 52 along a central axis (not shown). The enlongated cavity 56 is generally-cylindrical with a pointed upper end 58 for accommodating the pin end of the jack 10.

The tool 48 includes a downwardly-protruding central core 60 that extends below the bottom edge 62 of the body 64 of the hammer 52. As can be seen in the views of FIGS. 3(b) and 3(c), an open circular channel 66 is formed within the bottom edge 62 of the hammer 52 which surrounds the circumference of the open bottom of the elongated vertical cavity 56. The inner side of the channel 66 communicates with the tapered sidewall 68 of the downwardly-protruding central core 60 of the hammer 52. It will be seen below that the protruding central core 60 of the hammer 52 enables the jack 10 to be compressively-swaged to a panel by preventing the inward collapse of the barrel of the jack during swaging.

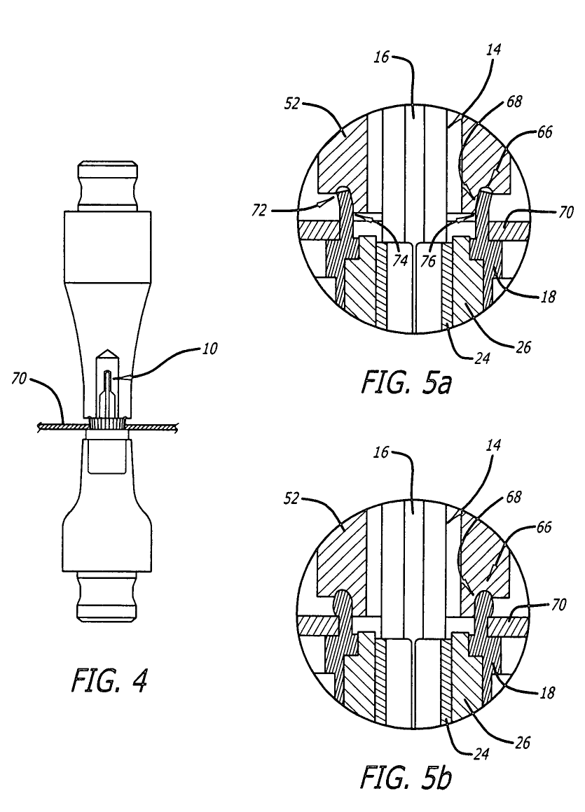

FIG. 4 is a side elevation view of the swaging tool 48 with jack 10 arranged therein for fixation to a panel 70 of an electronic module while FIGS. 5(a) and 5(b) are enlarged cross-sectional views for illustrating the swaging of a jack to the panel 70 in accordance with an embodiment of the invention. As discussed above, prior art jacks are formed of thin sheet metal that is amenable to a swaging process that involves the creation of a rolled upper edge at the obverse side of a mounting panel. The creation of such a rolled edge relies upon (1) the relative thinness of the sheet metal of the barrel and (2) the use of a swaging tool (hammer) having a flat bottom with the inner edge of an open circular channel at the bottom thereof aligned with the unstressed barrel. Upon application of a downwardly-acting force by the hammer, the barrel is captured within the open circular channel and rolled outwardly to contact the upper surface of the mounting panel.

Such prior art jacks and the associated swaging process often result in unsatisfactory fixation of jack to panel. They rely entirely upon the outward expansion of the portion of the barrel that resides within a port in the mounting panel. Such expansion necessarily occurs as the hammer advances downwardly and intimate contact takes place between the rolled edge of the barrel and the surface of the mounting panel adjacent the panel. The thinness of the material of the barrel prevents the creation of a knurled surface capable of contributing to resistance to the angular stresses that routinely result, for example, upon insertion and removal of electrical contacts. Also, the stretching of the free edge of the barrel can fracture the material of the barrel, if insufficiently resilient. Either can result in complete structural failure or periodic open-circuit connection between the shell of the jack and a metal panel.

In contrast, the machined jack 10 and the swaging tool 48 cooperatively create a clamped connection to the mounting panel 70 that is highly resistant to angular stresses that are routinely encountered during use.

FIG. 5(a) illustrates the jack 10 seated within the tool 48 for affixation to the mounting panel 70 during the initial stage of application of a downward-acting force from the hammer 52. As can be seen, the upper edge 72 of the barrel 20, whose inner surface 74 is aligned with the lower edge 76 of the tapered sidewall 68 of the downwardly-protruding central core 60 of the hammer 52 is received within the open circular channel 66 and, as a downwardly-acting force is applied by the hammer 52, the upper edge 72 of the barrel 20 begins to bend outwardly.

The barrel 20 is further downwardly compressed by the hammer 52 during swaging. Comparing the views of FIGS. 5(a) and 5(b), it can be seen that the material of the barrel 20 in the region of an upper edge 72 is guided outwardly by the tapered sidewall 68 of the protruding central core 60 of the hammer until the top of the upper edge 72 is fully captured within the open circular channel 66. Thereafter, continued downward compressive force exerted by the hammer 52 causes some expansion in the width of the region of the upper edge 72 as shown in FIG. 5(b). Such expansion is accompanied by outward bending of the portion of the barrel 20 throughout the thickness of the mounting panel 70. Such outward bending is a result of the downward force combined with the guidance provided by the tapered sidewall 68 of the central core 60. Keeping in mind that the outer surface of the barrel 20 is knurled, such outward bending causes the knurled surface of the barrel 20 to embed the inner periphery of the port of the panel 70 into which the jack 10 is being mounted whereby the outer surface of the barrel 20 is interlocked with the interior of such port. Such a bond is substantially more resistant to angular and rotational forces of the type routinely encountered during use than that afforded by a conventional jack that has been roll swaged to a mounting panel.

Thus it is seen that the present invention provides a jack, method of affixation to a mounting panel and tool for mounting that offer a bond of improved quality to that offered by conventional jacks and known swaging processes. By utilizing the teachings of the invention, one may obtain a bond between jack and mounting panel that is substantially unaffected by repeated applications of torque to the jack. The bond thereby provided enables the electrical connection afforded by the jack to be essentially immune from shorting and other deleterious phenomena that would otherwise reflect degradation of contact between the jack and electrical ground.

While this invention has been described with reference to its presently preferred embodiment, it is not limited thereto. Rather, the invention is limited only insofar as it is defined by the following set of patent claims and includes within its scope all equivalents thereof.

What is claimed is:

1. A method for securing a jack having a generally-cylindrical outer shell to a substantially-circular port of a planar panel of an electronics chassis, said panel being of the type that comprises spaced-apart upper and lower surfaces, said method comprising the steps of:
a) providing a jack of the type that includes a barrel having a flange encircling said outer shell; and
b) providing a first swaging tool member that includes a body having a lower surface, an open circular channel formed in said lower surface that comprises a pair of spaced-apart planar walls, an inner wall being of lesser diameter and an outer wall being of greater diameter than the diameter of an open end of the barrel of the jack; then
c) inserting said jack into said circular port so that said flange contacts said lower surface of said panel and said barrel extends beyond said upper surface of said panel; then
d) aligning said first swaging tool member with said open end of said jack so that the end of said barrel is circumscribed by said open circular channel of said swaging tool; then
e) applying a force to said swaging tool so that said lower surface of the tool is directed to contact said open end of said jack and exert a compressive force upon said barrel of said jack.

2. A method as defined in claim 1 wherein said step of providing a first swaging tool member includes the step of providing a first swaging tool member further characterized by:
a) said lower surface comprising a peripheral portion exterior to said outer wall of said open circular channel and an interior portion within said inner wall of said open circular channel; and
b) said interior portion extends beneath said peripheral portion of said lower surface.

3. A method as defined in claim 2 wherein said step of providing a jack further includes the step of providing a jack having an inwardly-tapered interior section.

4. A method as defined in claim 2 wherein said step of providing a jack further includes the step of providing a jack having at least one longitudinal knurl at an exterior surface of said barrel.

5. A method as defined in claim 3 wherein said outer shell of said barrel is machined from metal stock.

6. A method as defined in claim 5 is machined from brass.

7. A method as defined in claim 1 further including the steps of:
a) providing a second swaging tool member; and then
b) positioning said jack within said second swaging tool member prior to applying said force; and then
c) maintaining said position of said second swaging tool as said force is applied.

8. A method as defined in claim 7 wherein said step of providing a second swaging tool member further includes the step of:
a) providing a body of said second swaging tool member; and
b) providing a chamber for receiving said jack, said chamber being upwardly-open, within said body of said second swaging tool member.

9. A jack comprising, in combination:
a) a generally-cylindrical outer shell barrel;
b) a barrel having a flange encircling said outer shell; and
c) said barrel including an inwardly-tapered interior section.

10. A jack as defined in claim 9 further including at least one longitudinal knurl at an exterior surface of said barrel.

11. A jack as defined in claim 9 wherein said outer shell is formed by machining metal stock.

12. A jack as defined in claim 11 wherein said outer shell comprises brass.

13. A swaging tool comprising, in combination:
a) a first and a second swaging tool member;
b) said first swaging tool member comprising (i) a body having a lower surface, (ii) an open circular channel in said lower surface and (iii) said circular channel including a pair of spaced-apart planar walls and a planar roof.

14. A swaging tool as defined in claim 13 wherein said first swaging tool member further includes:
a) said circular channel comprising spaced-apart outer and inner planar walls;
b) said lower surface comprising an peripheral portion exterior to said outer wall and an interior portion within said inner wall of said open circular channel; and
c) said interior portion extends beneath said peripheral portion of said lower surface.

15. A swaging tool as defined in claim 14 wherein said second swaging tool member further includes:
a) a body of said second swaging tool member; and
b) an upwardly-open chamber within said body of said second swaging tool member.

16. A swaging tool as defined in claim 15 further characterized in that:
a) said body of said first swaging tool member is generally symmetrical with respect to a central axis; and
b) said body of said second swaging tool member is generally symmetrical with respect to said central axis.

17. A swaging tool as defined in claim 16 wherein said interior portion of said lower surface of said first swaging tool member and said upwardly-open chamber of said second swaging tool member are aligned and symmetrical with respect to said central axis.
